(19) United States
(12) Patent Application Publication
(10) Pub. No.: US 2017/0116670 A1
(43) Pub. Date: Apr. 27, 2017

(54) DISPLAYING HIGH/LOW RANGE ON VALUE AXIS

(71) Applicant: TRADING TECHNOLOGIES INTERNATIONAL INC., CHICAGO, IL (US)

(72) Inventors: Steven J. CARROLL, Hoffman Estates, IL (US); Patrick J. ROONEY, St. Charles, IL (US)

(21) Appl. No.: 14/919,314

(22) Filed: Oct. 21, 2015

(51) Int. Cl. G06Q 40/04

(52) U.S. Cl. CPC G06Q 40/04

(57) ABSTRACT

Users of trading devices may use trading applications to buy and sell tradeable objects at electronic exchanges. The trading devices may receive price information for the tradeable objects from the electronic exchange. Price information for multiple tradeable objects may be received at the trading device and displayed in a value axis in a user interface. The value axis may be non-linear, as the value axis may include different ranges of prices related to the tradeable objects. The user interface may provide indicia of price information related to an identified tradeable object, such as options having the same expiry for example, such that the user may identify the relevant price information for the tradeable object. The indicia may indicate a highest available price and/or a lowest relative price for the tradeable object relative to the prices in the value axis.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

The trading device may display the prices and quantities received in the information from the electronic exchange to a user. For example, the prices and quantities may be displayed to the user in a value axis that identifies a range of prices for the market to a user. When the prices and quantities being displayed in a value axis correspond to multiple objects that may be traded at the electronic exchange, it may be difficult for a user to determine prices that correspond to individual objects that may be traded at the electronic exchange. For example, users may trade on various options for underlying tradeable objects. The trading devices may display market data related to the various options for the tradeable objects to allow users to trade on those options. However, it may be difficult for a user to identify relevant price information for the various options related to underlying tradeable objects, such that a user may be able to accurately trade on such information.

Additionally, the value axis may be a non-linear value axis that may not expressly identify each of the prices received in the information from the electronic exchange to a user. Instead, the non-linear value axis may identify ranges of prices received in the information from the electronic exchange. The display of prices in a non-linear value axis may add to the difficulty for a user trying to identify relevant price information in the value axis, as many of the prices and/or quantities may not be expressly displayed to the user.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIGS. 4A and 4B illustrate example user interfaces that may be displayed on a computing device.

FIGS. 5A-5B illustrate other example user interfaces that may be displayed on a computing device.

FIG. 6 illustrates an example user interface that may be displayed on a computing device for providing options information.

FIG. 7 illustrates an example flow diagram of a method that may be implemented to display indicia on a computing device for providing pricing information related to one or more tradeable objects.

FIG. 8 illustrates a block diagram representative of an example system in which certain embodiments may be employed.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Systems, methods, and apparatus are described for generating and displaying indicia for price information related to tradeable objects. Users of a trading device may use a trading application to buy and/or sell tradeable objects at an electronic exchange. The trading devices may receive price information for the tradeable objects from the electronic exchange. Price information for multiple tradeable objects may be received at the trading device and displayed in a user interface. For example, the strike prices for multiple options for underlying tradeable objects, such as futures contracts, may be received at a trading device and may be displayed to a user via a user interface. The user interface may provide indicia of price information related to an identified tradeable object, such as options having the same expiry for example, such that the user may identify the relevant price information for the tradeable object.

The price information may be displayed in a value axis, such as a price ladder, that includes a predefined range of prices arranged vertically in an ascending or descending order. The predefined range of prices may be indicated in a number of cells within the value axis. One or more of the cells may include a range of prices. In certain embodiments, a low end of the cell may identify the lowest price represented by the cell and a high end of the cell may identify the highest price represented by the cell. As the price information may relate to multiple tradeable objects offered at an electronic exchange, the trading device may provide indicia indicating price information for an identified tradeable object relative to the predefined range of prices in the value axis.

In certain embodiments, the indicia may include a high bar that indicates the location of the highest available price related to the tradeable object when the highest available price is within the predefined range of the prices in the value axis. The trading device may identify a cell in the value axis that represents the range of prices that includes the highest available price and may place the high bar at a relative location within the cell that represents the highest available price. The relative location within the cell may be calculated as a percentage of the cell from a base price of the cell, for example.

In certain embodiments, the indicia may include a low bar that indicates the location of the lowest available price related to the tradeable object when the lowest available price is within the predefined range of the prices in the value axis. The trading device may identify a cell in the value axis that represents the range of prices that includes the lowest available price and may place the low bar at a relative location within the cell that represents the lowest available price. The relative location within the cell may be calculated as a percentage of the cell from a base price of the cell, for example.

In certain embodiments, the indicia may include a high-low indicator that indicates a price range between the highest available price and the lowest available price relative to the predefined range of the prices in the value axis. The high-low indicator may be displayed between the high bar and the low bar when the high bar and the low bar are displayed. The high-low indicator may be displayed from a high end of a high cell in the value axis when the highest available price is above the prices within the value axis. The high-low indicator may be displayed from a low end of a low cell in the value axis when the lowest available price is below the prices within the value axis. The high cell in the value axis may include the highest price range in the value axis. The low cell in the value axis may include the lowest price range in the value axis.

In an embodiment described herein, the trading device may display market data related to futures contracts tradeable at an electronic exchange. Strike prices may be identified in the market data that are related to the futures contracts. The strike prices may include the strike prices of futures instruments related to a plurality of expiries. The value axis may include cells that represent different ranges of strike prices related to a futures contract. The trading device may provide the indicia to indicate price information for a futures instrument having an identified expiry and the indicia may be displayed relative to the predefined range of strike prices in the value axis.

The embodiments described herein may be performed by a price analysis manager that resides on one or more computing devices. For example, the price analysis manager may reside on a trading device. The trading device may comprise one or more computing devices, such as a trading terminal or a trading terminal and a trading server. The price analysis manager may comprise software that may be distributed across the trading terminal and the trading server, or may reside at one of the trading terminal or the trading server. The software may be executed by a processor at the trading terminal or respective processors at the trading terminal and the trading server.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Systems, methods, and apparatus are described for generating and displaying indicia for price information related to tradeable objects. As described herein, market data may be received that related to a plurality of tradeable objects at an electronic exchange. Prices may be identified in the market data that are related to the plurality of tradeable objects. A value axis may be defined that comprises a plurality of cells that indicate a predefined range of the prices related to the plurality of tradeable objects. Each cell in the plurality of cells may represent a range of prices. A highest available price and a lowest available price may be determined that are related to a tradeable object of the plurality of tradeable objects. A determination may be made as to whether the highest available price and/or the lowest available price are within the predefined range of the prices related to the plurality of tradeable objects. Indicia may be displayed indicating a location of the highest available price and the lowest available price relative to the predefined range of prices in the value axis.

The indicia may include a high bar that indicates the location of the highest available price when the highest available price is within the predefined range of the prices related to the plurality of tradeable objects. When the highest available price is within the predefined range of the prices related to the plurality of tradeable objects, a cell may be identified of the plurality of cells in the value axis that represents the range of prices that includes the highest available price and a relative location within the cell may be calculated that represents the highest available price. The relative location within the cell may be calculated as a percentage of the cell from a base price of the cell.

The indicia may include a low bar that indicates the location of the lowest available price when the lowest available price is within the predefined range of the prices related to the tradeable object. When the lowest available price is within the predefined range of the prices related to the plurality of tradeable objects, a cell may be identified of the plurality of cells in the value axis that represents the range of prices that includes the lowest available price and a relative location within the cell may be calculated that represents the lowest available price. The relative location may be calculated as a percentage of the cell from a base price of the cell.

The indicia may include a high-low indicator that indicates a price range between the highest available price and the lowest available price relative to the predefined range of the prices in the value axis. The high-low indicator may be displayed from at least one of a high end of a high cell in the plurality of cells in the value axis or a low end of a low cell in the plurality of cells in the value axis. The high cell may include the highest price range in the value axis. The low cell may include the lowest price range in the value axis.

As further described herein, market data may be received that is related to a futures contract tradeable at an electronic exchange. Strike prices may be identified in the market data that are related to the futures contract. The strike prices may include the strike prices of futures instruments related to a plurality of expiries. A value axis may be defined that includes a plurality of cells that indicate a predefined range of the strike prices related to the futures contract. Each cell in the plurality of cells may represent a range of strike prices. A highest available strike price and a lowest available strike price may be determined that are related to one of the plurality of expiries. A determination may be made as to whether the highest available strike price and/or the lowest available strike price are within the predefined range of the strike prices related to the futures contract. Indicia may be displayed that indicate a location of the highest available strike price and the lowest available strike price relative to the predefined range of strike prices in the value axis.

The indicia may include a high bar that indicates the location of the highest available strike price when the highest available strike price is within the predefined range of the strike prices related to the futures contract. When the highest available strike price is within the predefined range of the strike prices related to the futures contract, a cell of the plurality of cells in the value axis may be identified that represents the range of strike prices that includes the highest available strike price and a relative location within the cell may be calculated that represents the highest available price. The relative location may be calculated as a percentage of the cell from a base price of the cell.

The indicia may include a low bar that indicates the location of the lowest available strike price when the lowest available strike price is within the predefined range of the strike prices related to the futures contract. When the lowest available strike price is within the predefined range of the strike prices related to the futures contract, a cell of the plurality of cells in the value axis may be identified that represents the range of strike prices that includes the lowest available strike price and a relative location within the cell may be calculated that represents the lowest available price. The relative location may be calculated as a percentage of the cell from a base price of the cell.

The indicia may include a high-low indicator that indicates a price range between the highest available strike price and the lowest available strike price relative to the predefined range of the strike prices in the value axis. The high-low indicator may be displayed from at least one of a high end of a high cell in the plurality of cells in the value axis or a low end of a low cell in the plurality of cells in the value axis. The high cell may include the highest price range in the value axis. The low cell may include the lowest price range in the value axis. The plurality of cells in the value axis may be centered around a center strike price for a group of options related to the futures contract.

The embodiments described herein may be performed by a price analysis manager that resides on one or more computing devices. For example, the price analysis manager may reside on a trading device. The trading device may comprise one or more computing devices, such as a trading terminal or a trading terminal and a trading server. The price analysis manager may comprise software that may be distributed across the trading terminal and the trading server, or may reside at one of the trading terminal or the trading server. The software may be executed by a processor at the trading terminal or respective processors at the trading terminal and the trading server.

### II. Example Electronic Trading System

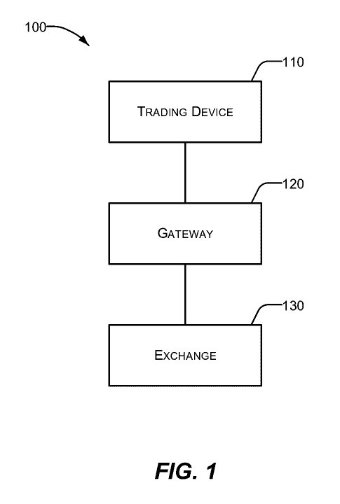

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

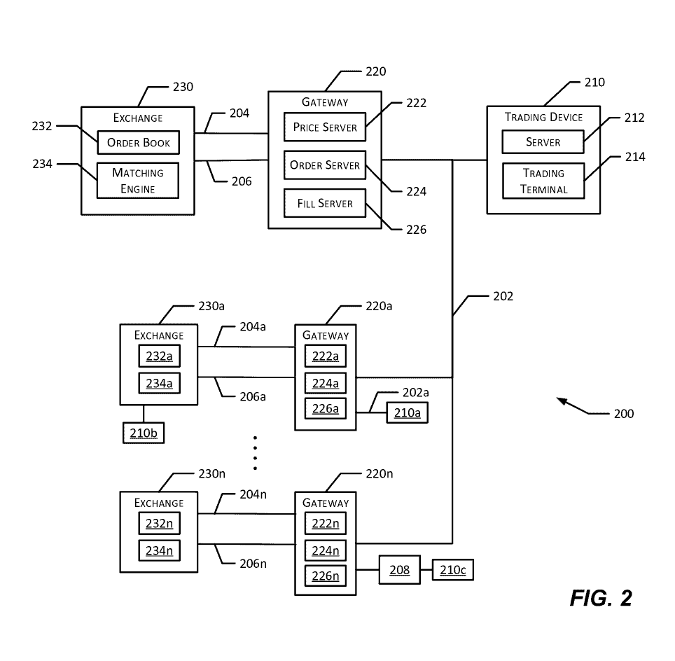

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

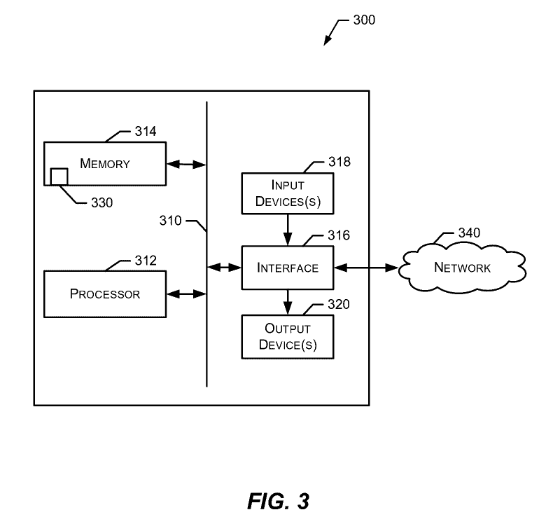

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Example Interface for Displaying High/Low Range on Value Axis

Users of a trading device may utilize a trading application to buy and/or sell tradeable objects offered at an electronic exchange. The trading application may display prices related to the tradeable objects in a value axis, such as a price ladder, in an ascending or descending order. The trading application may display the prices along a linear value axis or a non-linear value axis. The linear value axis displays available prices in cells arranged such that the difference between each displayed value is a consistent amount. The non-linear value axis displays available prices arranged such that the difference between each displayed value may vary from cell to cell. The trading application may also display a bid quantity and/or an offer quantity that is available at the electronic exchange aligned and/or otherwise associated with each price in the value axis.

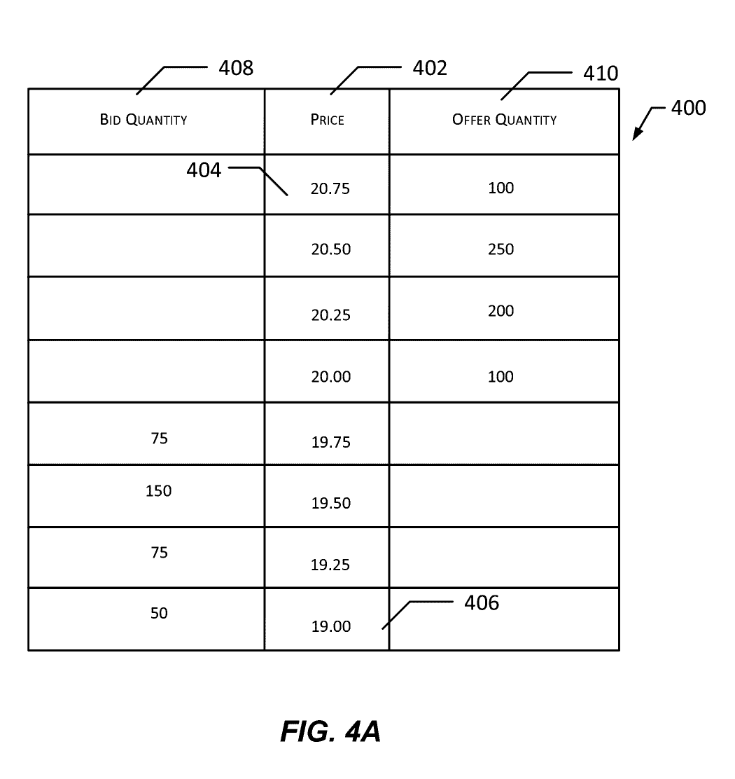

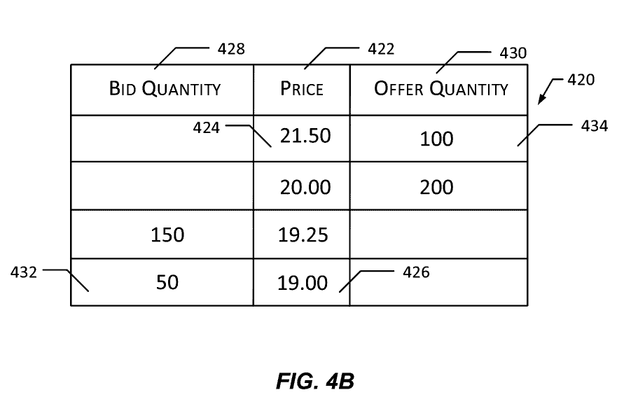

FIGS. 4A and 4B illustrate examples of user interfaces 400 and 420, respectively, that may be displayed on a computing device to identify prices related to a tradeable object offered at an electronic exchange. The interfaces 400, 420 may be generated at one or more computing devices for being displayed. For example, the interfaces 400, 420 may be generated and displayed locally on a computing device, or may be generated at a computing device for being displayed remotely on another device (e.g., via a remote application or web interface). In an example, the interfaces 400, 420 may be generated by a trading application that may be executed on a trading server for being displayed on a trading terminal, or the interfaces 400, 420 may be generated locally at the trading terminal for being displayed to a user.

As shown in FIG. 4A, the interface 400 may include a value axis 402 that may identify each of the prices available for a tradeable object at an electronic exchange. The value axis may include prices, derivatives of prices and other indicators of value and relative value. The value axis 402 may be generated at a computing device from market data received from the electronic exchange. Each of the values and/or prices may be displayed in a respective cell in the value axis 402. For example, each cell in the value axis 402 may identify a corresponding price that is available for a tradeable object at an electronic exchange. The value axis 402 may include the range of available prices for the tradeable object. The value axis 402 may include a high cell 404 that represents the highest price in the value axis 402 and a low cell 406 that represents the lowest price in the value axis 402. The high cell 404 and the low cell 406 may be the same cell. The high cell 404 may identify the highest available price for the tradeable object at an electronic exchange. The low cell 406 may identify the lowest available price for the tradeable object at the electronic exchange.

The value axis 402 may include a predefined range of available prices for a tradeable object. The value axis 402 may include a cell that may identify each of the prices available for the tradeable object at an electronic exchange, or each of the prices in a subset of prices that are available for the tradeable object at the electronic exchanges. For example, the value axis 402 may display a predefined range of prices in twenty-five cent increments, which are the increments of the prices available for the tradeable object at the electronic exchange. If the range of available prices for the tradeable object is larger than the subset of prices currently displayed in the value axis 402, the user may scroll up or down in the value axis 402 to view additional prices. For example, the high cell 404 that identifies the highest available price for the tradeable object and/or the low cell 406 that identifies the lowest available price for the tradeable object may not be displayed within the range of prices being displayed in the value axis 402, so the user may scroll up to view the high cell 404 or down to view the low cell 406. The computing device may receive an indication from the user to scroll up or down on the interface 400 (e.g., identifying a selection of a respective button, identifying a respective gesture for scrolling up or down, etc.).

The interface 400 may include a bid quantity 408 and/or an offer quantity 410 aligned and associated with the available prices displayed in the value axis 402, if available. The bid quantity 408 and/or the offer quantity 410 may be included in the interface 400 by the computing device according to the market data received from the electronic exchange. The bid quantity 408 may identify the quantity of available bids for a tradeable object that are available at a corresponding price in the value axis 402. The offer quantity 410 may identify the quantity of available offers for a tradeable object that are available at a corresponding price in the value axis 402. The bid quantity 408 and/or the offer quantity 410 for each price in the value axis 402 may be displayed in the same row in the interface 400.

FIG. 4B illustrates another example of an interface 420 that may be displayed on a computing device to identify prices related to a tradeable object offered at an electronic exchange. As shown in FIG. 4B, the interface 420 may include a non-linear value axis 422, which may include cells that represent a range of prices available for a tradeable object at an electronic exchange. The non-linear value axis 422 may be generated based on the same market data from which the value axis 402 shown in FIG. 4A may be generated. Each cell in the non-linear price value axis 422 may represent one or more prices that may be offered for the tradeable object at the electronic exchange. For example, the price value axis 422 may explicitly display prices in different increments (e.g., twenty-five, seventy-five and one hundred and fifty cent increments) than the set of increments offered for the tradeable object at the electronic exchange (e.g., which may be twenty-five cent increments as illustrated in the value axis 402 shown in FIG. 4A).

Each of the cells in the non-linear value axis 422 may represent a range of prices that may be offered for the tradeable object at the electronic exchange. For example, the non-linear value axis 422 may include a low cell 426 that may represent the prices in the range from 19.00 at the bottom of the cell to 19.25 at the top of the cell. The low cell 426 may also represent the price increment of 19.00, which is displayed in the value axis 402 of the interface 400 illustrated in FIG. 4A. The non-linear value axis 422 may include a high cell 424 that may represent the prices in the range from 20.00 at the bottom of the cell to 21.50 at the top of the cell. The high cell 424 may also represent the price increment of 20.75, which is displayed in the value axis 402 of the interface 400 illustrated in FIG. 4A.

Each of the cells in the non-linear value axis 422 may explicitly display a base price represented by the cell (e.g., 21.50 for the high cell 424, 19.00 for the low cell 426, etc.). The base price may be the low-end price of the price range represented by the cell. Though the cells in the value axis 422 explicitly display the base price represented by the cell, the cells may also, or alternatively, display another price, such as the high-end price of the price range represented by the cell, the mid-price of the price range represented by the cell, or the range of prices represented by the cell, for example. If the range of available prices for the tradeable object is larger than the subset of prices currently displayed in the value axis 422, the user may scroll up or down in the value axis 422 to view additional prices.

The interface 420 may include a bid quantity 428 and/or an offer quantity 430 for the tradeable object associated and aligned with each of the available prices explicitly displayed in the value axis 422. The bid quantity 428 and/or the offer quantity 430 may be included in the interface 420 by the computing device according to the market data received from the electronic exchange. The bid quantity 428 may identify the quantity of available bids for a tradeable object that are available at the corresponding price explicitly displayed in the value axis 422. For example, the bid quantity 432 may correspond to the quantity of bids available at the price of 19.00 that is explicitly displayed in the low cell 426 in the value axis 422. The offer quantity 430 may identify the quantity of available bids for a tradeable object that are available at the corresponding price explicitly displayed in the value axis 422. For example, the offer quantity 434 may correspond to the quantity of bids available at the price of 21.50 that is explicitly displayed in the high cell 424 in the value axis 422. The bid quantity 428 and/or the offer quantity 430 for each price in the value axis 422 may be displayed in the same row in the interface 420. Though the bid quantity 428 and the offer quantity 430 may identify the quantity of available bids for a tradeable object that are available at the corresponding price explicitly displayed in the value axis 422, the bid quantity 428 and the offer quantity 430 may identify quantities available for the entire range of a corresponding cell in the value axis 422.

Though the cells within the non-linear value axis 422 may represent a specified number of increments and/or a specified price range that may be available for a tradeable object at an electronic exchange, the interface 420 may similarly display a non-linear price ladder that includes cells that represent any number of increments and/or any price ranges. Additionally, although the cells within the non-linear value axis 422 may be evenly distributed across equal price ranges, the interface 420 may similarly display a non-linear price ladder that includes cells that represent different price ranges. Though the prices are listed in a descending order of price from top to bottom of each cell, the value axis 422 may be displayed in an ascending order of price from the top to the bottom of each cell.

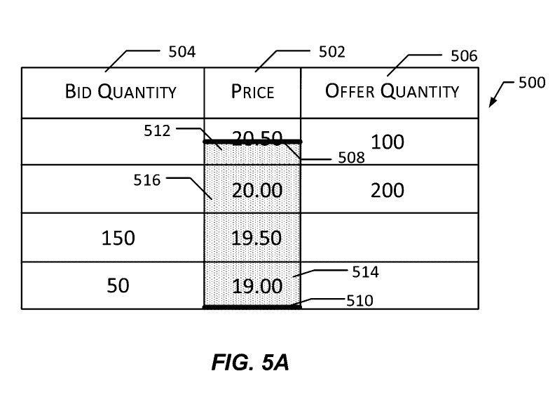

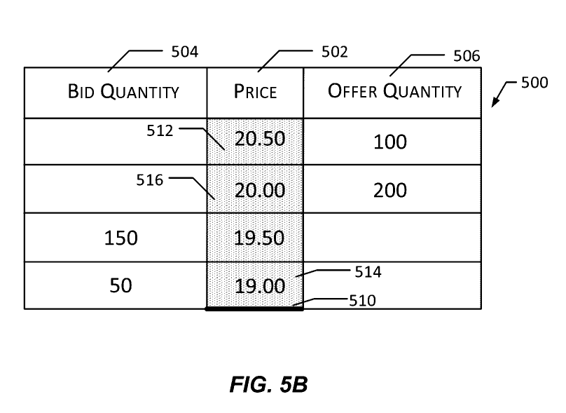

FIGS. 5A and 5B illustrate examples of a user interface 500 that may be displayed on a computing device to identify prices related to a tradeable object offered at an electronic exchange. The interfaces 500 may be generated at one or more computing devices for being displayed. For example, the interface 500 may be generated and displayed locally on a computing device, or may be generated at a computing device for being displayed remotely on another device (e.g., via a remote application or web interface). In an example, the interface 500 may be generated by a trading application that may be executed on a trading server for being displayed on a trading terminal, or the interface 500 may be generated locally at the trading terminal for being displayed to a user.

As shown in FIG. 5A, the interface 500 may include a value axis 502 that may identify each of the prices available for one or more tradeable objects at an electronic exchange. The value axis 502 may be generated at a computing device from market data received from the electronic exchange. The value axis 502 may include a predefined range of prices that are included from a high cell 512 that includes the highest price in the value axis 502 to a low cell 514 that includes the lowest price in the value axis 502.

The value axis 502 includes one or more vertically aligned cells indicating a range of prices from 19.00 to 20.50 where each cell represents a fifty cent increment relative to the adjacent cell(s). In certain embodiments, the value axis 502 may be a non-linear price ladder (see the value axis 422 shown in FIGS. 4A and 4B) in which one or more cells (e.g., each cell) may identify a range of prices that may be available for the one or more tradeable objects at the electronic exchange. Each of the cells illustrated as part of the value axis 502 represents a range of prices may have a high end that represents the highest price of the cell and a low end that represents the lowest price of the cell. For example, the high cell 512 may represent a range from 20.50 to 21.00 and the low cell may represent a range from 19.00 to 19.50. Each cell in the value axis may explicitly display the lowest price represented by the cell, the highest price represented by the cell, a range of prices represented by the cell, or a combination thereof. As the cells in the value axis 502 are displayed in a descending order from top to bottom, the high end of each cell is above the low end. The cells may alternatively be displayed in an ascending order from top to bottom making the high end of each cell towards the bottom of the cell and the low end of the cell towards the top of the cell.

The interface 500 may include a bid quantity 504 and/or an offer quantity 506 for the tradeable object. The bid quantity 504 and offer quantity 506 may include the quantity for each of the available prices explicitly displayed in the value axis 502 or for the range or prices represented by a corresponding cell in the price ladder. The bid quantity 504 and/or the offer quantity 506 may be included in the interface 500 by the computing device according to the market data received from the electronic exchange. The bid quantity 504 and/or the offer quantity 506 for each price in the value axis 502 may be displayed in the same row in the interface 500 as a corresponding cell in the value axis 502.

The interface 500 may include indicia that indicates a highest available price related to a tradeable object, a lowest available price related to a tradeable object, a price range between the highest available price and the lowest available price for the tradeable object, or a combination thereof relative to the prices displayed in the value axis 502. Where the value axis 502 includes a predetermined range of prices for a plurality of tradeable objects at an electronic exchange, the indicia may indicate relevant prices related on one of the tradeable objects. For example, the value axis 502 may include a high bar 508 and/or a low bar 510, which may represent the highest available price and the lowest available price, respectively, for an identified tradeable object at the electronic exchange. The high bar 508 and/or the low bar 510 may be generated at the computing device from the market data received from the electronic exchange. The computing device may identify the highest available price for the tradeable object at the electronic exchange and determine the location of the high bar 508 relative to the cells in the value axis 502. The computing device may identify the lowest available price for the tradeable object at the electronic exchange and determine the location of the low bar 510 relative to the cells in the value axis 502. The high bar 508 and the low bar 510 may be a different color, pattern, or the like to be able to distinguish between the two bars.

The relative location of the high bar 508 within a cell may indicate the relative price identified by the high bar 508 within the price range identified by the cell. As shown in the interface 500, the high bar 508 is displayed at the center of the high cell 512, which indicates that the highest available price for the tradeable object is at the price represented by the center of the high cell 512. As the price range represented by the high cell 512 is between 20.50 and 21.00, the high bar 508 indicates that the highest available price for the tradeable object is 20.75. The relative location of the high bar 508 may be calculated at the computing device by identifying that the highest available price for the tradeable object is within the price range represented by the high cell 512 and calculating the position of the high bar 508 within the high cell 512 from a base price of the cell. The base price of each cell may be the price from which the relative location of the indicia (e.g., high bar 508, low bar 510, etc.) within the cell may be calculated. The base price may be the low end price of the cell in the calculations performed herein, but the location of the indicia may be calculated from other locations within the cell, such as the high end of the cell or the mid-value of the cell, for example.

The relative location of the low bar 510 within a cell may indicate the relative price identified by the low bar 510 within the price range identified by the cell. As shown in the interface 500, the low bar 510 is displayed low end of the low cell 514, which indicates that the lowest available price for the tradeable object is at the price represented by the low end of the cell 514. As the price range represented by the cell 514 is between 19.00 and 19.50, the low bar 510 indicates that the lowest available price is 19.00 for the tradeable object. The relative location of the low bar 510 may be calculated at the computing device by identifying that the lowest available price for the tradeable object is within the price range represented by the low cell 514 and calculating the position of the low bar 510 within the low cell 514. The low bar 510 may be calculated from a base price of the cell. Since the base price of the low cell 514 is equal to the lowest available price for the tradeable object, the computing device may display the low bar 510 at the base price of the low cell 514. Though the cells in which the high bar 508 and the low bar 510 are displayed in FIG. 5A are different, the high bar 508 and the low bar 510 may be displayed in the same cell.

The price range represented by each cell in the value axis 502 is the same, but the price range represented by the cells in the value axis 502 may be different. Additionally, the price range represented by each cell in the price axis 502 is fifty cents, but the price range may be larger or smaller for a cell in a price ladder. The price range may be calculated based on the type of tradeable object for which the value axis 502 is being displayed and/or the available prices at the electronic exchange.

The interface 500 may include a high-low indicator 516 that may indicate the price range between the highest available price and the lowest available price for the tradeable object. The high-low indicator 516 may be displayed within the value axis 502 between the high bar 508 and the low bar 510. The computing device may generate the high-low indicator 516 and overlay the high-low indicator 516 over the price ladder in between the high bar 508 and the low bar 510. The high-low indicator 516 may be shaded or colored to indicate the price range.

FIG. 5B shows another example of the user interface 500 at a time when the highest available price for the tradeable object at the electronic exchange is different from the highest available price shown in FIG. 5A. As shown in FIG. 5B, the computing device may receive market data that indicates that the highest available price is at a price higher than the high cell 512 displayed in the value axis 502. For example, the market data may be received in an update message and may indicate that the highest available price for the tradeable object is at 22.00.

As shown in FIG. 5B, the value axis 502 may include a predefined range of prices that is a subset of the total range of prices available for a tradeable object at an electronic exchange. For example, the value axis 502 may include a predefined range of prices that may be centered on a given price or prices, such as the best available bid and/or the best available offer, and displays a predefined number of cells above and below the center price. As shown in the interface 500, the value axis 502 is centered around the price of 20.00 and displays two cells above and below the center price. The interface 500 may include any number of prices in the predefined range represented by the value axis 502.

The computing device may determine that the highest available price for the tradeable object is higher than the predefined range of prices displayed in the value axis 502 and may not display the high bar 508 within a cell in the value axis 502. The computing device may display the high-low indicator 516 between the low bar 510 and the high end of the high cell 512 displayed in the value axis 502 to indicate that the highest available price is higher than the price ranges displayed in the value axis 502.

Though not shown in FIG. 5B, the computing device may similarly determine that the lowest available price for the tradeable object is lower than the predefined range of prices displayed in the value axis 502 and may not display the low bar 510 within a cell in the value axis 502. The computing device may display the high-low indicator 516 between the high bar 508 (when present) and the low end of the low cell 514 displayed in the value axis 502 to indicate that the lowest available price is lower than the price ranges displayed in the value axis 502. The interface 500 may determine that neither the highest available price nor the lowest available price are within the predetermined range of prices displayed in the value axis 502 and may not display the low bar 510 or the high bar 508. The high-low indicator 516 may be displayed between the high end of the high cell 512 and the low end of the low cell 514 to indicate that neither the highest available price nor the lowest available price are within the predetermined range of prices displayed in the value axis 502.

Though the top of the cells in the value axis 502 may represent the high end of the cells and the bottom of the cells may represent the low end of the cells in FIG. 5B, the value axis 502 may be displayed such that the bottom of the cells represent the high end and the top of the cells represent the low end. The indicia may be calculated and displayed according to the different cell formats. Also, though not shown in FIG. 5B, the computing device may display the highest available price and/or the lowest available price for the tradeable object. For example, the interface 500 may separately display the highest available price of 22.00 and/or the lowest available price of 19.00, as used in the example in FIG. 5B. The highest available price and/or the lowest available price may be separately displayed when located outside of the predefined range of prices being displayed in the value axis 502.

The tradeable object for which the predefined range of prices in the value axis 502 are displayed may include, for example, financial products, stocks, options, bonds, future contracts, currency, warrants, funds derivatives, securities, commodities, swaps, interest rate products, index-based products, traded events, goods, or a combination thereof. In an example, the value axis 502 may be used to indicate strike prices for options on underlying futures contracts. The price at which the options for an underlying futures contract may be purchased or sold may be referred to as the strike price. The strike price may be the price a futures contract may go above (for calls) or below (for puts) before a position may be exercised for a profit. A call may give the user the right to buy the futures contract at the strike price within a specific period of time before the option expires. A put may give the user the right to sell the futures contract at the strike price within a specific period of time before the option expires.

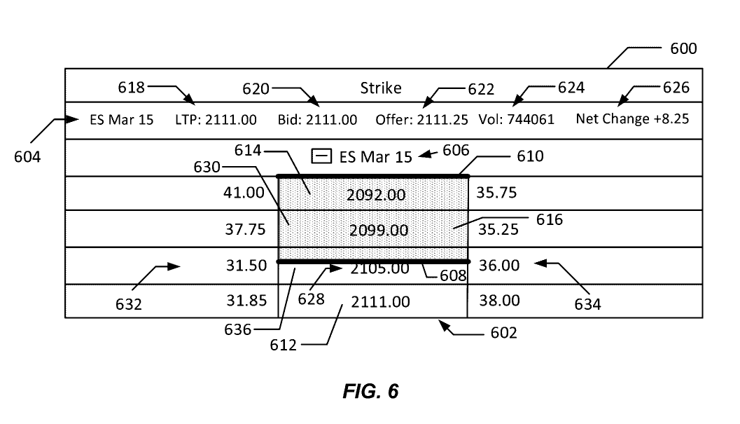

FIG. 6 illustrates an example of a user interface 600 that may be displayed on a computing device to identify strike prices for options on underlying futures contracts offered at one or more electronic exchanges. The interface 600 may be generated at one or more computing devices for being displayed. For example, the interface 600 may be generated and displayed locally on a computing device, or may be generated at a computing device for being displayed remotely on another device (e.g., via a remote application or web interface). In an example, the interface 600 may be generated by a trading application that may be executed on a trading server for being displayed on a trading terminal, or the interface 600 may be generated locally at the trading terminal for being displayed to a user.

A computing device may generate and display the interface 600 based on market data received at the computing device. The market data may relate to one or more futures contracts, such as futures contract 604 for example. The futures contract 604 may be identified by the financial product type (e.g., “ES”), the month code, and/or the year identifier. The market data may include options for different expiries related to futures contract 604, such as expiry 606 for example. The market data for the futures contract 604 may include the inside market, market depth, a last traded price 618, and/or price levels associated with the inside market and market depth. The inside market for the futures contract 604 may include a highest available bid 620 and/or a lowest available offer 622 at an electronic exchange. The market depth for the futures contract 604 may include the volume 624 available at price levels, including the inside market. The price levels associated with the inside market and market depth can be provided as a value level, such as the net change 626 from an opening price for the futures contract 604.

The interface 600 may display option information for options of the underlying futures contract 604. For example, the interface 600 may display a value axis 602 that may include a predefined range of strike prices for options of the underlying futures contract 604. The value axis 602 may include a number of cells that include different ranges of strike prices related to the futures contract 604. The value axis 602 may include a subset of the total strike prices for the groups of options that may be available for the underlying futures contract 604.

As the market data may include options information for different expiries related to futures contract 604, the computing device may center the predefined range of strike prices in the value axis 602 around the current market of the futures contract 604 for the different expiries. For example, the predefined range of strike prices in the value axis 602 may be centered around a center strike price 628. The center strike price 628 may represent the strike price that is closest to the current market for the futures contract 604. As shown in the interface 600, the value axis 602 is centered around a price that lies between 2099.00 and 2105.00, and the interface 600 displays two cells above and below the price. In certain embodiments, the center strike price 628 may, for example, be estimated based on a best bid price, and/or a best ask price, the difference between a high price and a low price, when no current market exists for the futures contract 604.

Each of the cells in the value axis 602 may explicitly identify a price that represents the base price (or low price) within the price range identified by the cell. For example, the value axis 602 may include a high cell 612 that may explicitly identify the price 2111.00, which may be the base strike price represented by the high cell 612. The high cell 612 may represent the price range from 2111.00 to 2118.00, which may be the highest strike price represented by the value axis 602. The value axis 602 may include a low cell 614 that may explicitly identify the price 2092.00, which may be the base strike price represented by the low cell 614 and may be the lowest strike price represented by the value axis 602. The low cell 614 may represent the price range from 2092.00 to 2099.00, which may be the base strike price represented by the next cell 630 in the value axis 602. The high cell 612 may represent the highest range of strike prices in the value axis 602, while the low cell 614 may include the lowest range of strike prices represented by the value axis 602.

The value axis 602 is a non-linear price ladder, as the cells in the value axis 602 represent ranges of strike prices. The range of strike prices represented by the cells in the value axis 602 is different. In certain embodiments, the range of strike prices may be the same for each cell. The low cell 614 represents a price range of seven strike prices (e.g., 2092.00 to 2099.00), the next cell 630 in the value axis 602 represents a price range of six strike prices (e.g., 2099.00 to 2105.00), the next cell 636 in the value axis 602 represents a price range of six ticks or increments (e.g., 2105.00 to 2111.00) and the high cell 612 includes a price range of seven ticks or increments (e.g., 2111.00 to 2118.00).

Though the cells in the value axis 602 include two cells above and below the center price 628 that include specified price ranges, the predefined cells in the value axis 602 may take on different configurations. The predefined range of strike prices in the value axis 602 may include the closest relative strike prices to the center strike price 628 for a group of options for the underlying futures contract 604. For example, the computing device may identify the closest relative strike prices above and below the center strike price for being displayed in the value axis 602. Though the interface 600 may include a single center strike price 628, the interface 600 may display multiple center strike prices.

The predefined range of strike prices in the value axis 602 may be configured by the user or may be otherwise predefined at the computing device. The interface 600 illustrates a value axis 602 that includes four ranges of strike prices. However, the value axis 602 may include any number of strike prices. The predefined range of strike prices in the price ladder may be generated by counting a number of price ranges above and below the center strike price 628.

As the predefined range of strike prices in the value axis 602 include strike prices for the available options related to one or more futures instruments, such as futures instruments having a number of different expiries, the value axis 602 may include indicia that indicate strike prices available for options on the futures contract 604 that relate to the expiry 606. For example, the indicia may indicate a highest available strike price associated with the futures instruments having the expiry 606, a lowest available strike price associated with the futures instruments having the expiry 606, a price range between the highest available strike price and the lowest available strike price of the futures instruments having the expiry 606, or a combination thereof relative to the strike prices displayed in the value axis 602.

The value axis 602 may include a high bar 608 and/or a low bar 610. In operation, the high bar 608 and the low bar 610 may represent the current high price and the current low price, respectively, of the underlying futures contract 604. In certain embodiments, the high bar 608 and the low bar 610 may represent the highest available strike price and the lowest available strike price, respectively, of the options having the expiry 606. The high bar 608 and/or the low bar 610 may be generated at the computing device from the market data received from the electronic exchange. In certain embodiments, the computing device may identify the current high price for a given time period and the current low price for a given time period of the underlying futures contract 604. For example, the computing device may identify the current daily high price for the futures contract 604 and determine the location for the high bar 608 relative to the cells in the value axis 602. Similarly, the computing device may identify the current daily low price for the futures contract 604 and determine the location for the low bar 610 relative to the cells in the value axis 602. The high and low prices represented by the high bar 608 and the low bar 610 may reflect the highest and lowest prices, respectively, at which the futures contract 604 has traded during a fixed time period. The fixed time period may be a user-defined time period such as, for example, a trading day or session, an hour, fifteen minutes or any other time period of interest to the user. In this way, the user can quickly visualize the range of prices over which the futures contract 604 has traded during a period of time relative to the ranges of strike prices for the options displayed adjacent to the value axis 602.

In certain embodiments, the high bar 608 and the low bar 610 may represent the highest available strike price and the lowest available strike price, respectively, of the options having the expiry 606. For example, the computing device may identify the highest available strike price for options on futures contract 604 that have the expiry 606 and determine the location of the high bar 608 relative to the cells in the value axis 602. The computing device may identify the lowest available strike price for options on the futures contract 604 that have the expiry 606 and determine the location of the low bar 610 relative to the cells in the value axis 602. In this way, the user can quickly visualize the current strike prices for the options on futures contract 604 relative to the ranges of strike prices for those options displayed adjacent to the value axis 602.

The relative location of the high bar 608 within the value axis 602 may indicate the relative strike price identified by the high bar 608 within the predefined range of strike prices within the value axis 602. The computing device may determine the relative location of the high bar 608 by identifying the highest available strike price for options on the futures instruments having the expiry 606 and identifying the cell within the value axis 602 that represents the identified price. The computing device may display the high bar 608 at a location within the cell that represents a range of strike prices that includes the highest available strike price for options on the futures instruments having the expiry 606. For example, the highest available strike price for options on the futures instruments having the expiry 606 may be 2107.00. The computing device may determine that the highest available strike price comes within the cell 636 that represents the range of strike prices from 2105.00 to 2111.00 and may place the high bar 608 within the cell 636.

The high bar 608 may be placed within the cell 636 at a location that indicates the highest available strike price relative to the price range represented by the cell 636. For example, the computing device may calculate the highest available strike price as a relative percentage of the range of strike prices represented by the cell 636 and may display the high bar at the calculated percentage value within the cell 636. The highest available strike price may be calculated as a relative percentage from the base price (e.g., lowest value) of the cell 636 as compared to the range of strike prices represented by the entire cell.

As shown in FIG. 6, the high bar 608 is placed one third of the distance from the base strike price represented by cell 636. The computing device may calculate the percentage of the highest available price (e.g., 2107.00) from the base price of the cell 636 (e.g., 2105.00) when compared to the total range of strike prices represented by the entire cell (e.g., 2105.00 to 2111.00). The percentage in the example provided is one third, which may be the distance from the base price of cell 636 at which the high bar 608 may be displayed. The distance of the high bar 608 from the base price of the cell 636 indicates the relative price indicated by the high bar 608.

The relative location of the low bar 610 within the value axis 602 may indicate the relative strike price identified by the low bar 610 within the predefined range of strike prices within the value axis 602. The computing device may determine the relative location of the low bar 610 by identifying the lowest available price for futures instruments having the expiry 606 and identifying the cell within the value axis 602 that represents the identified price. The computing device may identify the lowest available strike price for futures instruments having the expiry 606 as being at a base price of the low cell 614 (e.g., 2092.00) and may display the low bar 610 at the base of the low cell 614. The lowest available strike price for the futures instrument may be identified at a location within the low cell 614 and may be displayed at a location within the low cell 614 based on the percentage of the lowest available strike price from the base strike price as compared to the range of strike prices represented by the low cell 614 (e.g., the range of strike prices from 2092.00 to 2099.00).

As shown in FIG. 6, the low bar 610 is placed at the base strike price represented by cell 614. The computing device may calculate the percentage of the lowest available strike price (e.g., 2092.00) from the base price of the cell 636 (e.g., 2092.00) when compared to the total price range represented by the entire cell (e.g., 2092.00 to 2099.00). As the lowest available strike price is located at a base price of a cell, the computing device may identify the lowest available strike price as the base price of the low cell 614 and may display the low bar 610 at the low end of the cell 614 represented by the base price. This may avoid the computing device having to calculate the percentage of the low cell 614 at which the low bar 610 may be placed.

Though the high bar 608 and the low bar 610 may be in different cells in the value axis 602, the bars may be displayed in the same cell. For example, the computing device may identify that the highest available strike price and the lowest available strike price for futures instruments having the expiry 606 both fall within the range of strike prices represented by the same cell. The location of the high bar 608 and the low bar 610 within the cell may similarly be displayed as a percentage of the entire range of strike prices represented by the cell.

The interface 600 may include a high-low indicator 616 that may indicate the price range between the highest available strike price and the lowest available strike price for the tradeable object relative to the range of strike prices in the value axis 602. The high-low indicator 616 may be displayed within the value axis 602 between the high bar 608 and the low bar 610. The high-low indicator 616 may be shaded or colored to indicate the range of strike prices. Where the high bar 608 and/or the low bar 610 are not included in the interface 600, the high-low indicator 616 may be displayed from the high-end of the high cell 612 and/or the low-end of the low cell 614, respectively. For example, the highest available strike price and/or the lowest available strike price for futures instruments having the expiry 606 may fall outside of the predefined range of strike prices represented by the value axis 602, which may prevent the high bar 608 and/or the low bar 610 from being displayed, respectively, in the interface 600.

The predefined range of strike prices in the value axis 602 may be updated in real-time upon receipt of updated market data at a computing device to identify the current relevant strike prices for the options of the underlying futures contract 604. For example, the predefined range of strike prices 602 may be updated based on market data (e.g., bid prices and/or offer prices), such that as the market goes up or down (e.g., due to changes in the bid prices and/or offer prices), the values in the center strike price 628 may be updated to show users the relevant market data for purchasing options. The indicia that indicate available strike prices of the futures contract 604 that relate to the expiry 606 may be similarly updated when the strike prices in the value axis 602 are updated. For example, the computing device may update the location of the high bar 608, the low bar 610, the high-low indicator 616, or a combination thereof relative to the strike prices displayed in the value axis 602.

The options for the strike prices being displayed in the value axis 602 may be stored at the computing device with the corresponding call price 632 and/or put price 634. The computing device may display the stored call price 632 and/or the stored put price 634 alongside the corresponding strike price in the interface 600. If the options do not include a current call price 632 or a current put price 634, the respective call price value or put price value may be stored as a null value or zero value and may not be displayed.

Though the interface 600 includes options information for a single contract 604, the interface 600 may include options information for multiple contracts. For example, the interface 600 may include respective price ladders for different futures contracts. Additionally, though the interface 600 includes indicia related to a single expiry 606, the interface 600 may include indicia related to multiple expiries. The indicia for each expiry may be displayed in the value axis 602 with a different identifier (e.g., color, pattern, etc.) or the indicia for each expiry may be displayed in respective price ladders. For example, the interface 600 may include a respective price ladder for multiple futures instruments related to the contract 604, but having a different expiry.

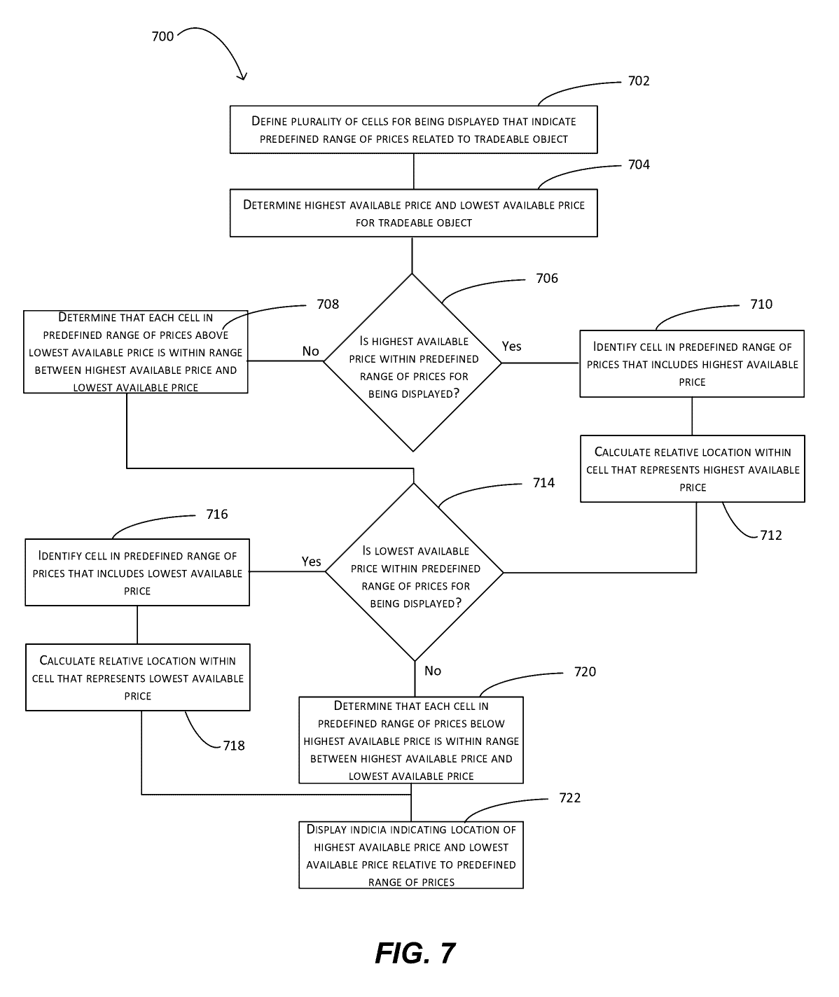

FIG. 7 illustrates an example flow diagram of a method 700 for determining and displaying indicia of the highest available price and/or the lowest available price for a tradeable object at one or more electronic exchanges. In an example, the method 700 may be performed to determine and/or display indicia of a highest available strike price and/or a lowest available strike price for options related to underlying futures contracts. The method 700, or portions thereof, may be performed by one or more computing devices, such as a trading device or another computing device. In an example, the method 700, or portions thereof, may be performed by a price analysis manager residing at one or more computing devices.

As shown in FIG. 7, a computing device may define a plurality of cells at 702 for display that indicate a predefined range of prices related to a tradeable object. The plurality of cells may be a number of cells in a price ladder that includes a predefined range of prices related to the tradeable object. The plurality of cells may be a number of cells above and below a center price, for example. One or more of the cells may include a range of prices for being displayed in the price ladder. The cells in the price ladder may include a range of prices from a base price to the base price of the next cell in the price ladder.

At 704, the computing device may determine a highest available price and a lowest available price for the tradeable object. The highest and lowest available price and the lowest available price may be a highest available strike price and a lowest available strike price, respectively, for options related to underlying futures contracts. The highest available price and the lowest available price may be identified, at 704, from market data received at a computing device.

The computing device may determine, at 706, whether the highest available price is within the predefined range of prices for being displayed. For example, the computing device may determine whether the highest available price is within the predefined range of prices for being displayed in the price ladder. If the highest available price is not within the predefined range of prices for being displayed at 706, the computing device may decide that a high bar may not be displayed, as the highest available price may be outside of the predefined range of prices in the price ladder. At 708, the computing device may determine that each cell in the price ladder above the lowest available price may be indicated as being between the highest available price and the lowest available price. The computing device may decide, at 708, that the high-low indicator may be displayed from the high end of the high cell in the price ladder to the low bar or the low end of the low cell to indicate that the highest available price related to the tradeable object is above the predefined range of prices displayed in the price ladder.

If the highest available price is within the predefined range of prices for being displayed at 706, the computing device may identify, at 710, the cell in the price ladder that includes the highest available price related to the tradeable object. For example, the computing device may compare the highest available price with the price range of one or more cells of the price ladder (e.g., starting at the top or bottom of the price ladder) until the computing device identifies the cell within which the highest available price is located.

At 712, the computing device may calculate the relative location within the cell that represents the highest available price. For example, the computing device may calculate the distance of the highest available price from the base price of the cell as a percentage of the price range of the entire cell. Equation 1 below shows an example equation that may be used by the computing device to calculate the percentage of the highest available price within a given cell.

Pct=((Price−CurrentBasePrice)/(NextBasePrice−CurrentBasePrice))*100.0 (Equation 1)

Where the Price may be the highest available price, the CurrentBasePrice may be the base price of the cell in which the highest available price may be located, and the NextBasePrice may be the base price of the next cell (e.g., next higher priced cell) in the price ladder. Where the price ladder does not include a next cell in the price ladder, the NextBasePrice may be the highest price in the price ladder. As the cells in the price ladder may include different price ranges, Equation 1 may be used to calculate the relative location of a price within any cell in the price ladder.

In an example, the highest available strike price for options related to an underlying futures contract may be 2116.25, which may fall within a cell having a range from 2115.00 to 2120. Applying Equation 1 to the example,

Pct=((2116.25−2115.00)/(2120.00−2115.00))*100=25%,

which the computing device may calculate for displaying the high bar at a location twenty-five percent into the cell from the base price.

The computing device may determine, at 714, whether the lowest available price is within the predefined range of prices for being displayed. For example, the computing device may determine whether the lowest available price is within the predefined range of prices for being displayed in the price ladder. If the lowest available price is not within the predefined range of prices for being displayed at 714, the computing device may decide that a low bar may not be displayed, as the lowest available price may be outside of the predefined range of prices in the price ladder. At 720, the computing device may determine that each cell in the price ladder below the lowest available price may be indicated as being between the highest available price and the lowest available price. The computing device may decide, at 720, that the high-low indicator may be displayed from the low end of the low cell in the price ladder to the high bar or the high end of the high cell to indicate that the lowest available price related to the tradeable object is below the predefined range of prices displayed in the price ladder.

If the lowest available price is within the predefined range of prices for being displayed at 714, the computing device may identify, at 716, the cell in the price ladder that includes the lowest available price related to the tradeable object. For example, the computing device may compare the lowest available price with the price range of one or more cells of the price ladder (e.g., starting at the top or bottom of the price ladder) until the computing device identifies the cell within which the lowest available price is located.

At 718, the computing device may calculate the relative location within the cell that represents the lowest available price. For example, the computing device may calculate the distance of the lowest available price from the base price of the cell as a percentage of the price range of the entire cell using Equation 1, where the Price may be the lowest available price, the CurrentBasePrice may be the base price of the cell in which the lowest available price may be located, and the NextBasePrice may be the base price of the next cell (e.g., next higher priced cell) in the price ladder.

In an example, the lowest available strike price for options related to an underlying futures contract may be 2102.75, which may fall within a cell having a range from 2100.00 to 2105. Applying Equation 1 to the example,

Pct=((2102.75−2100.00)/(2105.00−2100.00))*100=55%,

which the computing device may calculate for displaying the low bar at a location fifty-five percent into the cell from the base price.

The computing device may display indicia indicating the location of the highest available price and the lowest available price relative to the range of prices in the price ladder at 722. The indicia may include a high bar when the highest available price for the tradeable object is determined to be within the predefined range of prices for being displayed. The indicia may include a low bar when the lowest available price for the tradeable object is determined to be within the predefined range of prices for being displayed. The indicia may include a high-low indicator to identify the prices in the cells between the highest available price and the lowest available price. The indicia may include the actual price identified as the highest available price and/or the lowest available price (e.g., when the price is not within the predefined range of prices being displayed). The method 700 may be performed upon execution of an application, such as a trading application for example, and/or each time the price ladder is updated based on updated market data.

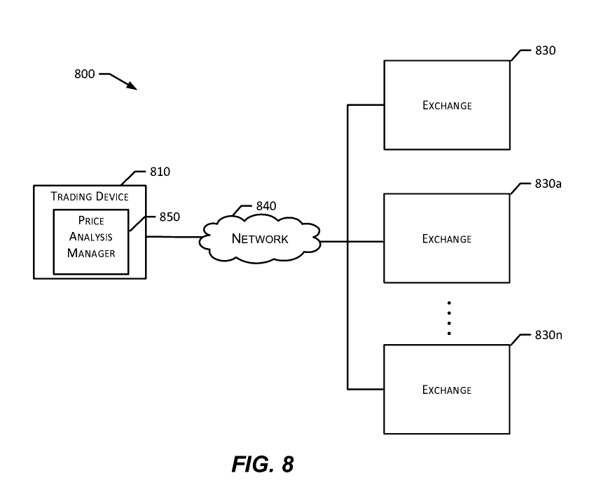

FIG. 8 illustrates a block diagram of an example system 800 that may be used to generate and/or provide pricing information related to one or more tradeable objects at one or more electronic exchanges. The system 800 may include a trading device 810 that may receive market data from one or more exchanges, such as exchange 830 and/or exchanges 830a to 830n. The trading device 810 may communicate with the exchanges directly or through a network 840. The market data from the exchanges 830 to 830n may correspond to one or more tradeable objects (e.g., futures contracts) at each market.

The market data may include prices and quantities (e.g., bid quantities and offer quantities) related to one or more tradeable objects. The market data may include information related to one or more futures contracts. The market data for a futures contract may include the inside market, market depth, a last traded price, and/or price levels associated with the inside market and market depth. The market data may include option information for one or more underlying futures contracts. For example, the market data may include a number of options related to an underlying futures contract and/or a strike price for each option. The option information may also include a call price or a put price for the option. The option information may indicate whether the option is a call or a put.

The market data may be received at the trading device 810 in response to a query from the trading device 810 or in an update message received periodically from the exchanges 830 to 830n. The market data may be received from the exchanges 830 to 830n in response to an update of the market data for one or more tradeable objects at the exchanges 830 to 830n. The trading device 810 may store the market data locally, at a remote device, or the market data may be distributed across multiple devices. For example, the trading device 810 may include a trading terminal and a trading server at which the market data may be stored.

The trading device 810 may be capable of generating and/or displaying a user interface that may indicate relevant pricing information related to one or more tradeable objects as described herein. As described above, the trading device 810 may be a trading server and/or a trading terminal. The functionality described herein may be performed on the trading terminal, the trading server, or may be distributed across the trading terminal and the trading server. For example, the trading device 810 may include a trading terminal capable of displaying a user interface for an application executing locally on the trading terminal or an application executing remotely on the trading server and accessed on an application at the trading terminal (e.g., via a web browser or other application).

The trading device 810 may include a price analysis manager 850, which may be executed locally at the trading terminal, at the trading server, or may be distributed across the trading terminal and the trading server. The price analysis manager may include a hardware and/or software module that may be executed at the trading device 810. The price analysis manager may be executed, from memory, by a processor located at a trading device 810. The price analysis manager 850 may perform analysis for generating a user interface that provides relevant price information related to one or more tradeable objects on a market. For example, the price analysis manager 850 may receive market data, analyze the market data, and/or generate a user interface that provides relevant information related to available a tradeable object on a market.

The price analysis manager 850 may identify relevant options related to one or more underlying futures contracts, group the options, and may display a predefined range of options that are representative of the current market. The price analysis manager 850 may identify relevant options based on the proximity of the strike prices of the options to a center strike price. The center strike price may represent the strike price for the current market for a group of options underlying a futures contract. The price analysis manager 850 may perform one or more of the embodiments described herein, or portions thereof, to generate and/or display a user interface that provides the relevant price information for one or more tradeable objects.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed:

1. A method for generating and displaying indicia for strike prices related to underlying tradeable objects, the method comprising:
receiving, via a price analysis manager, market data related to a tradeable object tradeable at an electronic exchange;
identifying, via the price analysis manager, strike prices in the market data that are related to the tradeable object, wherein the strike prices comprise strike prices of futures instruments related to a plurality of expiries;
defining, via the price analysis manager, a value axis that comprises a plurality of cells that indicate a predefined range of the strike prices related to the tradeable object, wherein each cell in the plurality of cells represents a range of strike prices;
determining, via the price analysis manager, a highest available strike price and a lowest available strike price related to one of the plurality of expiries;
determining, via the price analysis manager, whether the highest available strike price is within the predefined range of the strike prices related to the tradeable object;
determining, via the price analysis manager, whether the lowest available strike price is within the predefined range of the strike prices related to the tradeable object; and
displaying, via the price analysis manager, indicia indicating a location of the highest available strike price and a location of the lowest available strike price relative to the predefined range of the strike prices in the value axis.

2. The method of claim 1, wherein the indicia comprise a high bar that indicates the location of the highest available strike price when the highest available strike price is within the predefined range of the strike prices related to the tradeable object.

3. The method of claim 2, further comprising:
when the highest available strike price is within the predefined range of the strike prices related to the tradeable object:
identifying, via the price analysis manager, a cell of the plurality of cells in the value axis that represents the range of strike prices that includes the highest available strike price; and
calculating, via the price analysis manager, a relative location within the cell that represents the highest available strike price.

4. The method of claim 3, wherein the relative location is calculated as a percentage of the cell from a base price of the cell.

5. The method of claim 1, wherein the indicia comprise a low bar that indicates the location of the lowest available strike price when the lowest available strike price is within the predefined range of the strike prices related to the tradeable object.

6. The method of claim 5, further comprising:
when the lowest available strike price is within the predefined range of the strike prices related to the tradeable object:
identifying, via the price analysis manager, a cell of the plurality of cells in the value axis that represents the range of strike prices that includes the lowest available strike price; and
calculating, via the price analysis manager, a relative location within the cell that represents the lowest available strike price.

7. The method of claim 6, wherein the relative location is calculated as a percentage of the cell from a base price of the cell.

8. The method of claim 1, wherein the indicia comprise a high-low indicator that indicates a price range between the highest available strike price and the lowest available strike price relative to the predefined range of the strike prices in the value axis.

9. The method of claim 8, wherein the high-low indicator is displayed from at least one of a high end of a high cell in the plurality of cells in the value axis or a low end of a low cell in the plurality of cells in the value axis, wherein the high cell comprises a highest price range in the value axis, and wherein the low cell comprises a lowest price range in the value axis.

10. The method of claim 1, wherein the plurality of cells in the value axis are centered around a center strike price for a group of options related to the value axis.

11. A method for generating and displaying indicia for price information related to a tradeable object, the method comprising:
receiving, via a price analysis manager, market data related to a plurality of tradeable objects at an electronic exchange;
identifying, via the price analysis manager, prices in the market data that are related to the plurality of tradeable objects;
defining, via the price analysis manager, a value axis that comprises a plurality of cells that indicate a predefined range of the prices related to the plurality of tradeable objects, wherein each cell in the plurality of cells represents a range of prices;
determining, via the price analysis manager, a highest available price and a lowest available price related to a tradeable object of the plurality of tradeable objects;
determining, via the price analysis manager, whether the highest available price is within the predefined range of the prices related to the plurality of tradeable objects;
determining, via the price analysis manager, whether the lowest available price is within the predefined range of the prices related to the plurality of tradeable objects; and
displaying, via the price analysis manager, indicia indicating a location of the highest available price and a location of the lowest available price relative to the predefined range of the prices in the value axis.

12. The method of claim 11, wherein the indicia comprise a high bar that indicates the location of the highest available price when the highest available price is within the predefined range of the prices related to the plurality of tradeable objects.

13. The method of claim 12, further comprising:
when the highest available price is within the predefined range of the prices related to the plurality of tradeable objects:
identifying, via the price analysis manager, a cell of the plurality of cells in the value axis that represents the range of prices that includes the highest available price; and
calculating, via the price analysis manager, a relative location within the cell that represents the highest available price.

14. The method of claim 13, wherein the relative location is calculated as a percentage of the cell from a base price of the cell.

15. The method of claim 11, wherein the indicia comprise a low bar that indicates the location of the lowest available price when the lowest available price is within the predefined range of the prices related to the plurality of tradeable objects.

16. The method of claim 15, further comprising:
when the lowest available price is within the predefined range of the prices related to the plurality of tradeable objects:
identifying, via the price analysis manager, a cell of the plurality of cells in the value axis that represents the range of prices that includes the lowest available price; and
calculating, via the price analysis manager, a relative location within the cell that represents the lowest available price.

17. The method of claim 16, wherein the relative location is calculated as a percentage of the cell from a base price of the cell.

18. The method of claim 11, wherein the indicia comprise a high-low indicator that indicates a price range between the highest available price and the lowest available price relative to the predefined range of the prices in the value axis.

19. The method of claim 18, wherein the high-low indicator is displayed from at least one of a high end of a high cell in the plurality of cells in the value axis or a low end of a low cell in the plurality of cells in the value axis, wherein the high cell comprises a highest price range in the value axis, and wherein the low cell comprises a lowest price range in the value axis.

20. The method of claim 11, wherein the price analysis manager is executed by a processor at a trading device.
